(19) United States
(12) Patent Application Publication
(10) Pub. No.: US 2010/0189934 A1
(43) Pub. Date: Jul. 29, 2010

(54) PREFORM AND METHOD FOR PRODUCING A CONTAINER FOR HOLDING FLUIDS USED IN MEDICAL APPLICATIONS

(76) Inventors: Torsten Brandenburger, Reichelsheim (DE); Gerhard Greier, Friedrichsdorf (DE); Ismael Rahimy, Friedberg (DE)

Correspondence Address: HAMMER & ASSOCIATES, P.C., 3125 SPRINGBANK LANE, SUITE G, CHARLOTTE, NC, 28226, US

(21) Appl. No.: 12/663,930

(22) PCT Filed: Jun. 24, 2008
(86) PCT No.: PCT/EP2008/005064

§ 371 Date: Dec. 10, 2009

(30) Foreign Application Priority Data
Jun. 27, 2007 (DE) 10 2007 029 810.4

(51) Int. Cl. B32B 1/02; B29D 22/00; B29C 49/06; B29C 49/08; B32B 38/00

(52) U.S. Cl. 428/34.1; 264/572; 156/242

(57) ABSTRACT

The preform according to the invention for producing a container for medical fluids, which has a neck portion having an opening, which has a wall portion and which has a floor portion, is characterised in that one end of a first and a second sub-section is integrally formed on the underside of the floor portion, which ends can be connected together, following the production of the preform, to form an annular hanger for hanging the container up.

The invention relates to a preform for producing a container for holding fluids for medical applications, and in particular for holding infusion solutions or enteral nutrient solutions. As well as this, the invention also relates to a method for producing a container for holding fluids for medical applications and in particular infusion solutions or enteral nutrient solutions. The invention also relates to a container for holding fluids for medical applications.

A large number of containers of different designs for holding fluids are known. Containers for holding fluids for medical applications have to meet particular requirements, relating in particular to sterility.

There are known containers for medical fluids, such for example as bottles made of extruded polyethylene or polypropylene, which are produced to the desired shape, in a single operation and sterilely and while remaining pyrogen-free, by the bi-axial stretching and blow moulding of a preform, which are filled aseptically with a sterile filling on cooling and which are then hermetically sealed. The containers which are produced by this blow-fill-seal process, which are particularly bottles, are also referred to as BPS containers.

The known containers for infusion solutions or enteral nutrient solutions are generally hung from an upright. The containers have a hanger for this purpose. There are many known containers which have a hanger which is an integral part of the container. EP 070 641 A1 and U.S. Pat. No. 3,901,399 for example describe containers which have hangers integrally formed on their floor portions. The hangers take the form of eyes to allow the bottle to be hung from a hook.

EP 0 483 671 B1 describes a method of producing an infusion container which has an annular hanger on the base of the bottle. The bottle is produced by the bi-axial stretching and blowing of a preform. The preform itself is produced, together with the annular hanger, by the injection moulding process. The known method of production is distinguished by the fact that there is no need for a further operating step after the blow moulding to attach a hanger.

The object underlying the invention is to provide a preform with which a container for holding fluids for medical applications, and in particular for holding infusion solutions or enteral nutrient solutions, can be easily produced with a hanger. As well as this, it is also an object of the invention to specify an easily performed method for producing a container for holding medical fluids which has a hanger. A further object of the invention is to provide an easily produced container for holding medical fluids.

These objects are achieved in accordance with the invention by virtue of the features given in claims 1, 14 and 18. Advantageous embodiments of the invention form the subject matter of the dependent claims.

The preform according to the invention for producing a container for medical fluids, which has a neck portion having an opening, which has a wall portion and which has a floor portion, is characterised in that one end of a first and a second sub-section is integrally formed on the underside of the floor portion, which ends can be connected together, following the production of the preform, to form an annular hanger for hanging the container up.

The preform is produced first, the free ends of the two sub-sections not yet having been connected together. The container is then produced from the preform by stretching and blow-moulding. The method steps required for this purpose are familiar to the person skilled in the art.

The preform itself is preferably produced by the injection moulding process. The method steps required for this purpose are likewise familiar to the person skilled in the art. What is crucial is that when the preform is injection moulded the two sub-sections of the annular hanger are not yet connected together. This simplifies the injection moulding process for producing the preform. A relatively high speed of filling is obtained for the mould in the region of the hanger due to a smaller gate diameter resulting from having two gating points, thus shortening the cycle times. What is also obtained is an exact distribution of wall thicknesses and fast cooling and hence better detachment from the mould. What is more, use is made of the entire volume of the bottle.

The connection of the two sub-sections of the hanger may take place after the injection moulding process, such for example as during the stretching and blowing or even only at a later stage when it reaches the customer.

In a preferred embodiment of the preform, the first and second sub-sections are in the form of flexible strips. The flexibility required for the sub-sections to be deformed into the annular hanger can be achieved by selecting a material having adequate flexibility or by suitable sizing of the cross-section of the sub-sections.

In an embodiment which is a particular preference, provision is made for the flexible sub-sections to take the form of flat strips of a rectangular cross-section. This gives adequate flexibility even with a less flexible material. The material should always be sufficiently flexible as not to break when bent. However, what is also possible rather than a rectangular cross-section is a circular cross-section.

In another embodiment which is a particular preference, provision is made for those ends of the sub-section which are integrally formed on the underside of the floor portion to form a common base piece. The base piece preferably takes the form of a flat body which is integrally formed on the underside of the floor portion. The other parts of the flexible sub-sections extend outwards from the flat body. In these parts in particular, the two sub-sections are of adequate flexibility in this case. The base piece which is integrally formed on the floor portion on the other hand is substantially rigid.

The invention makes provision for two alternative embodiments which differ in that the free ends of the two sub-sections takes the form of end-pieces which are to be welded together in the first embodiment whereas the other embodiment has sub-sections whose free ends take the form of end-pieces which are to be connected together by positive interengagement.

In the first embodiment, either the end-faces of the end-pieces which are to be welded together are arranged opposite one another, in which case the sub-sections are welded directly together at the end-faces, or the ends to be welded together have additional projecting pieces having faces for contact which face towards one another and which are welded together, thus achieving a particularly strong welded connection. A further embodiment makes provision for it not to be the free ends of the two sub-sections or of their projecting pieces which are welded together but for the first and second sub-sections to form an annular body with the sub-sections overlapping one another around part of the circumference. It is possible in this way for the faces for contact, which face towards one another, of the overlapping sub-sections to be welded together, thus once again achieving a particularly strong connection.

In the alternative embodiment in which the free ends of the sub-sections take the form of end-pieces which are to be connected together by positive interengagement, the sub-sections may extend parallel to one another or may be shaped to be annular. Basically however, the sub-sections may be straight or curved before they are connected even in the embodiment having the ends to be welded together.

An embodiment which is a particular preference makes provision for the free ends of the two sub-sections to take the form of a snap-action or latching joint, thus enabling the connection of the sub-sections to take place even only when the customer is reached.

Various embodiments of the invention will be explained in detail in what follows by reference to the drawings.

In the drawings:

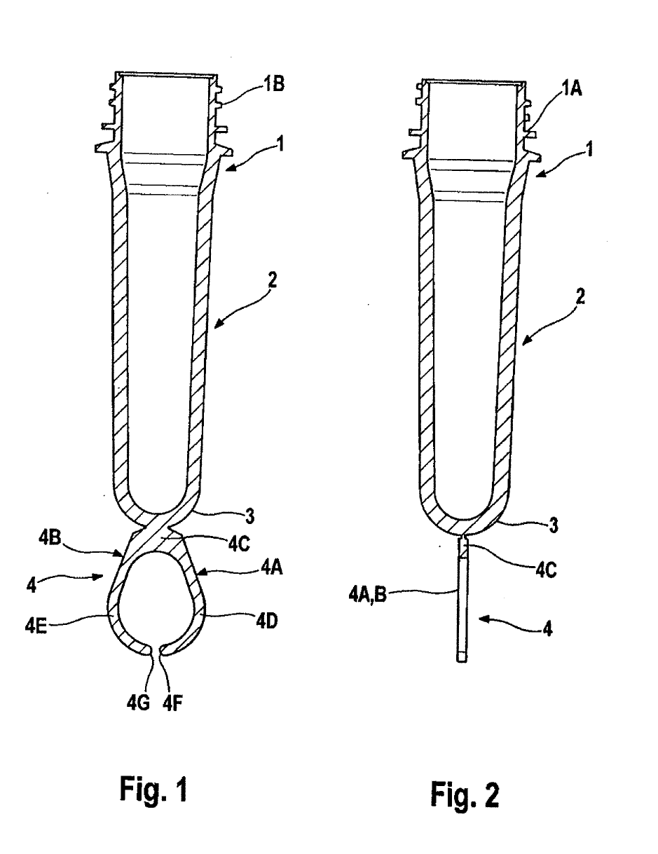

FIG. 1 is a view in section of a first embodiment of preform according to the invention in which the free ends of the sub-sections are welded together,

FIG. 2 is a section through the preform shown in FIG. 1,

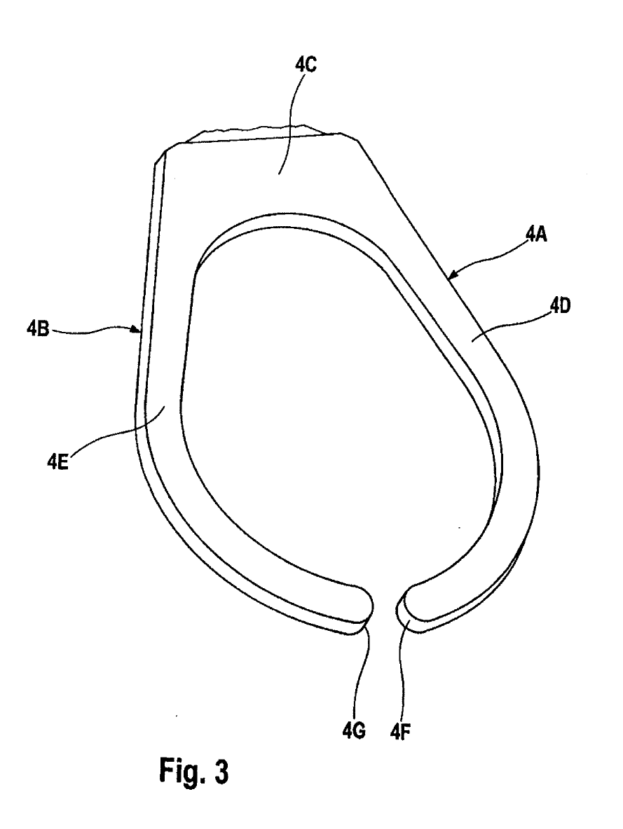

FIG. 3 is an enlarged perspective view of the hanger of the preform shown in FIG. 1,

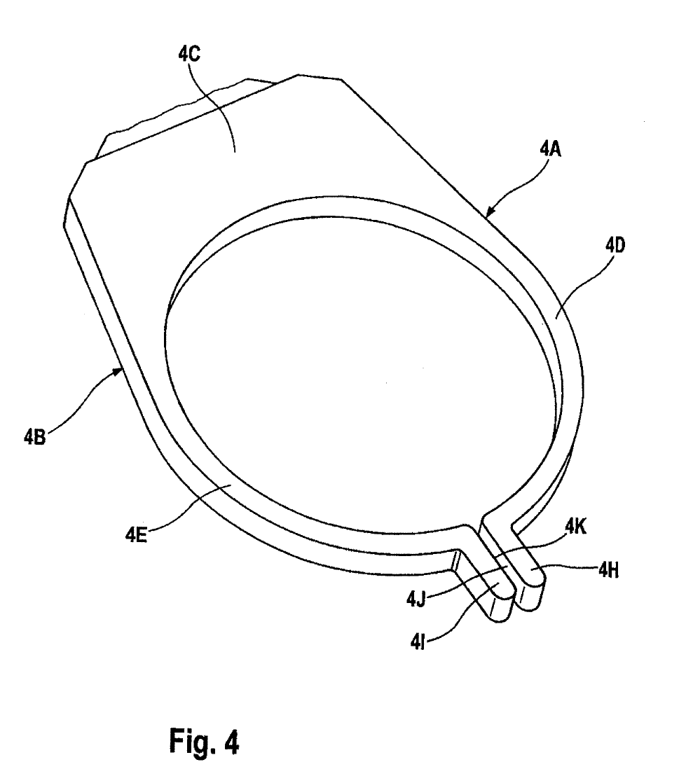

FIG. 4 is an enlarged perspective view of a second embodiment of the hanger of the preform according to the invention,

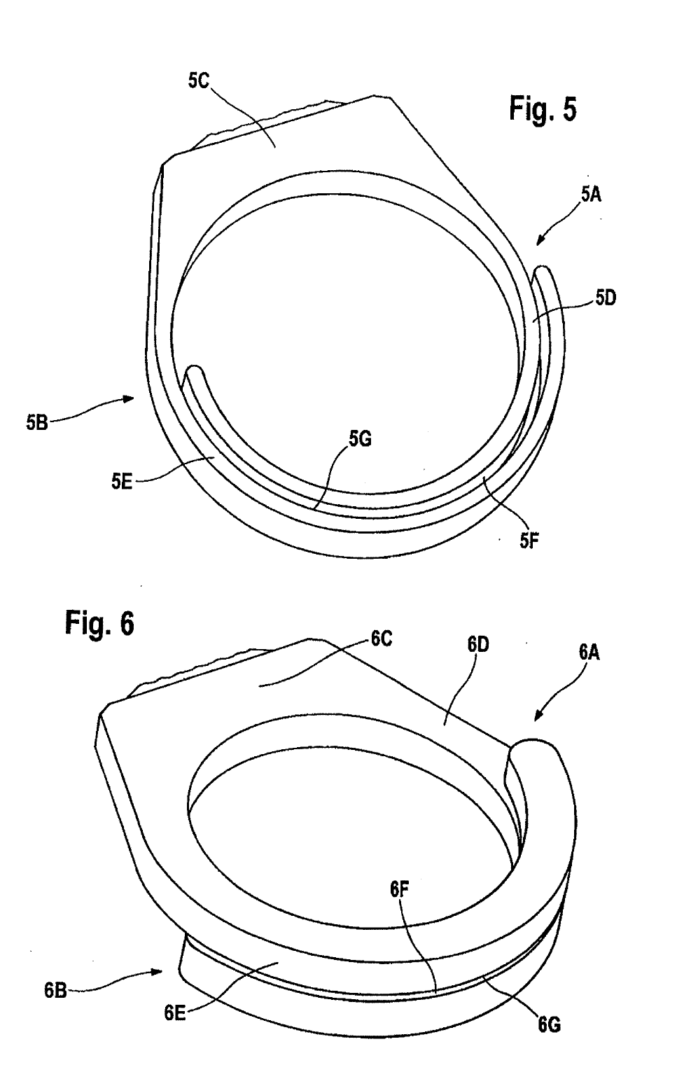

FIG. 5 is a perspective view of a third embodiment of the hanger,

FIG. 6 shows a fourth embodiment of the hanger,

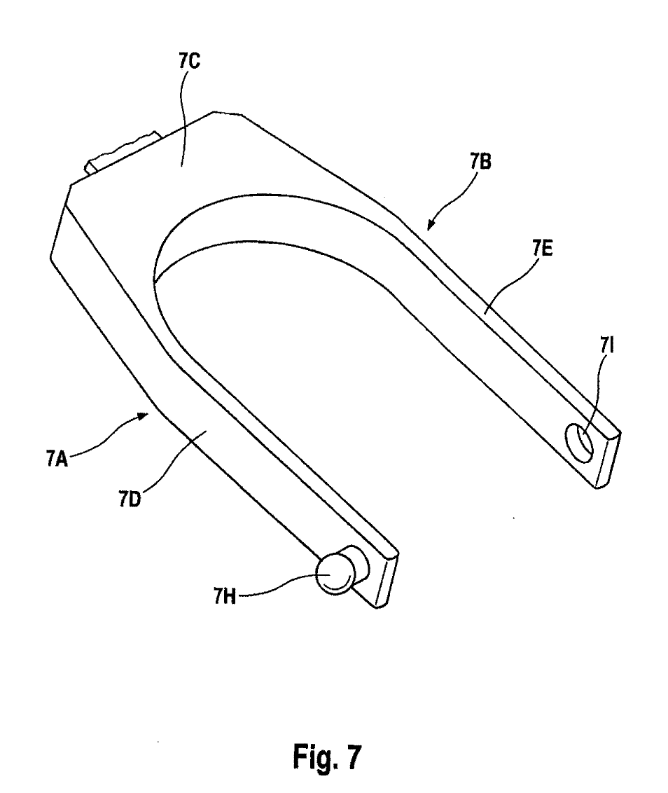

FIG. 7 shows an alternative embodiment of the hanger in which the free ends of the sub-sections are connected together by positive interengagement,

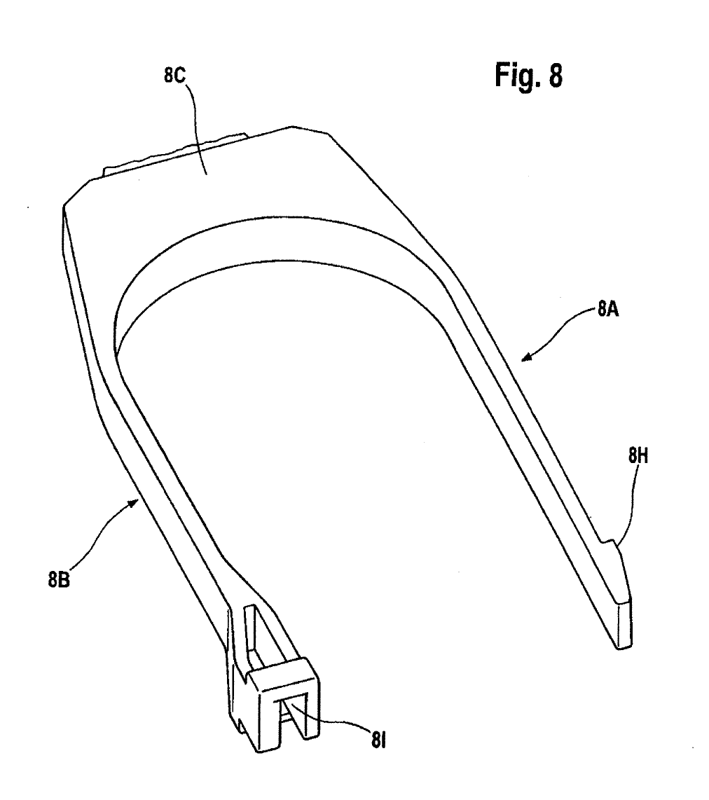

FIG. 8 shows a further embodiment of the hanger of the alternative embodiment,

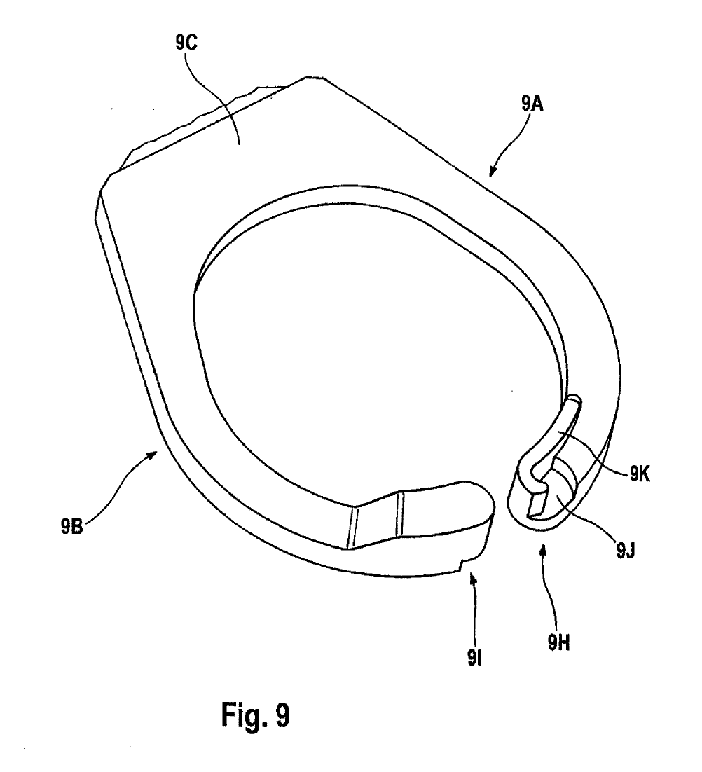

FIG. 9 shows a further embodiment of the hanger of the alternative embodiment.

FIGS. 1 and 2 are views in section showing a first embodiment of preform according to the invention for producing for producing a container for holding a medical fluid and in particular an infusion solution or an enteral nutrient solution. The preform is produced by the injection moulding process, and in particular by the injection moulding process involving two or three components of plastic material which is sufficiently strong, and in particular polypropylene (PP), polyethylene (PE), or PET or a combination of PP, PE and PET. The preform has a neck portion 1 with an opening 1A which is provided with an outside thread 1B. Following on from the neck portion 1 there is a wall portion 2 which merges with a floor portion 3.

Integrally formed on the underside of the floor portion 3 of the preform is a portion 4 made of plastics material which will subsequently form the hanger. The portion 4 of plastics material is an integral part of the preform. It comprises two sub-sections 4A, 4B which are integrally formed on the underside of the floor portion 3.

Those ends of the first and second sub-sections which are integrally formed on the underside of the floor portion form a common base piece 4C which takes the form of a flat body. Those sections 4D and 4E of the two sub-sections 4A and 4B respectively which start from the flat base body 4C are curved in an annular shape in such a way that the end-faces 4F, 4G of the sub-sections 4A, 4B are situated opposite and close to one another.

FIG. 3 is an enlarged perspective view showing the hanger before the free ends of the sub-sections are welded together. Those sections of the two sub-sections 4A, 4B which start from the flat base piece 4C are flat, flexible strips of a rectangular cross-section. They are sufficiently flexible for the sub-sections to be able to be bent towards one another easily and for the free ends to be able to be connected together by welding the end-faces 4F, 4G together. After the welding together of the ends, the hanger forms a substantially circular or oval eye.

The container is formed from the preform by bi-axial stretching and blowing by the known method. When this is done the form of the hanger remains unchanged. The two sub-sections of the hanger are not connected together until after the preform has been injection moulded. This simplifies the injection moulding. The welding operation is preferably performed during the stretching and blowing. Basically however, it is also possible for the two sub-sections to be welded together before the stretching and blowing but after the injection moulding.

FIG. 4 is an enlarged perspective view showing a second embodiment of the hanger according to the invention. Because the neck portion 1, wall portion 2 and floor portion 3 of the preform do not differ in this embodiment from the preform which has been described by reference to FIGS. 1 to 3, there is no need for the whole of the preform to be shown in FIG. 4. Parts which correspond to one another have been identified by the same reference numerals.

The second embodiment differs from the first embodiment in that projecting pieces 4H, 4I which project outwards and extend parallel to one another are integrally formed on the free ends of the sub-sections 4A, 4B. The faces for contact 4J, 4K, which are opposite and close to one another, of the two projecting pieces 4H, 4I are welded together. An easily made and particular strong welded connection is obtained by this means.

FIG. 5 shows a third embodiment of the hanger before the welding together of the two sub-sections 5A, 5B which terminate at the common flat base piece 5C which is integrally formed on the underside of the floor portion 3 of the preform. This embodiment differs from the first and second embodiments in that those sections 5D, 5E of the two sub-sections 5A, 5B which start from the base piece 5C are curved in an annular shape in such a way that the sections overlap one another for a given angle in the circumferential direction which may for example be 180°. In the region of overlap, the two sub-sections 5A, 513 are welded together at the two faces for contact 5F, 5G which are situated opposite and close to one another. A particularly strong welded joint is obtained in this way. What is more, the hanger is endowed with particularly high strength after the welding together, even though the sub-sections are flexible for the sake of the deformation.

Shown in FIG. 6 is a further embodiment which differs from the embodiment shown in FIG. 5 in that in the region of overlap those two sections 6D, 6E of the two sub-sections 6A, 6B which start from the flat sub-piece 6C are not situated next and close to another in the plane of the drawing (FIG. 5) but one above the other. The sub-sections 6A, 6B are likewise of a rectangular cross-section in this case, but are not curved to have respective narrow faces situated at the top and bottom (FIG. 5) but are curved to have respective wide faces situated at the top and bottom. The welding together of the two sub-sections takes place in the region of overlap between the wider, top face 6F of the bottom sub-section 6B and the wider, bottom face 6G of the top sub-section 6A.

By reference to FIGS. 7 to 9, there will be described in what follows further embodiments of alternative embodiments which differ from the embodiments which have been described by reference to FIGS. 1 to 6 in that the free ends of the sub-sections are connected together by positive interengagement.

FIG. 7 shows an embodiment in which the two sub-sections 7A, 7B which end in the common base piece 7C form the shape of a U. In this case, those sections 7D, 7E of the sub-sections 7A, 7B which start from the base piece 7C extend parallel to one another. Whereas a snap-action or latching member 711 having a spherical end-piece is integrally formed at the free ends of one sub-section 7A, the free end of the other sub-section 7B has a hole 71 into which the snap-action member 7H having the spherical end-piece is pressed to snap in, thus connecting the sub-sections of the hanger together in such a way that they cannot come free. The connection takes place after the injection moulding of the preform and preferably after the forming of the container by stretching and blow-moulding. After the two ends have been connected the hanger forms a substantially round or oval eye.

FIG. 8 shows a further embodiment of the alternative embodiments. The two sub-sections 8A, 8B having the common base piece 8C once again extend in parallel and form a U. In this embodiment, the free ends of the sub-sections 8A, 8B are connected together by means of a latching or snap-action joint. The free end of one sub-section 8A has a hook-like body 8H which tapers in the direction of its end at a shallow angle. The free end of the other sub-section 8B widens out to form a recess 81 which has an undercut. To connect the two sub-sections, the hook-like body 8H is slid into the undercut recess 81, by which means the two parts are connected together by a latch-in or snap-in action.

To enable the two sub-sections 9A, 9B, which extend in parallel before they are connected, to be bent easily, the sub-sections take the form of flat, flexible strips of which respective narrow faces are situated at the top and bottom in the plane of the drawing.

FIG. 9 shows a further embodiment of the alternative embodiment in which the two sub-sections 9A, 9B having the flat base piece 9C are already formed to be of an annular shape, which means that the sub-sections only need to be bent slightly to connect their free ends together. In this embodiment, respective wide faces of the sub-sections 9A, 9B are situated at the top and bottom in the plane of the drawing, whereas the narrow faces face outwards or inwards. Greater stiffness in bending is achieved in this way than in the embodiment shown in FIG. 8. The free ends of the two sub-sections 9A, 9B take the form of claw-like bodies 9H, 9I which engage in one another by positive interengagement when the sub-sections are fitted together. The claw-like bodies 9H, 9I on the sub-sections 10A, 10B have a flat web 9J, integrally formed on which is a rib 9K extending perpendicular thereto which swings inwards at the end.

1. A preform for producing a container for holding fluids for medical applications, and in particular for holding infusion solutions or enteral nutrient solutions, having:
a neck portion which has an opening (1A),
a wall portion (2), and
a floor portion (3), characterised in that one end of a first sub-section (4A) of an annular hanger for hanging said container up and one end of a second sub-section (4B) thereof being integrally formed on the underside of said floor portion (3), free ends of said first and second sub-sections being able to be connected together to form said annular hanger by deforming said sub-sections.

2. The preform according to claim 1, characterised in that said first and second sub-sections (4a, 4B) being in the form of flexible strips.

3. The preform according to claim 2, characterised in that the said flexible sub-sections (4a, 4B) taking the form of flat strips of a rectangular cross-section.

4. The preform according to claim 1, characterised in that said ends of said first and second sub-sections (4a, 4B) which are integrally formed on the underside of said floor portion (3) forming a common base piece (4C) which is integrally formed on the underside of said floor portion.

5. The preform according to claim 4, characterised in that said base piece (4C) taking the form of a flat body which is integrally formed on the underside of said floor portion (3).

6. The preform according to claim 1, characterised in that said free ends of said first and second sub-sections (4a, 4B) taking the form of ends which are to be welded and whose end-faces (4F, 4G) are arranged opposite one another.

7. The preform according to claim 6, characterised in that said ends of said first and second sub-sections (4a, 4B) which are to be welded together each having a projecting piece (4H, 4I), said projecting pieces forming end-pieces being arranged to have faces for contact (4J, 4K) which face towards one another.

8. The preform according to claim 1, characterised in that the said first and second sub-sections (5A, 5B; 6A, 6B) form an annular body, with said sub-sections overlapping one another around part of the circumference, thus causing those faces of said sub-sections which face towards one another to form faces for contact (5F, 5G; 6F, 6G) which are to be welded together.

9. The preform according to claim 1, characterised in that the free ends of the said first and second sub-sections (7A, 7B; 8A, 8B; 9A, 9B) take the form of end-pieces which are to be connected together by positive interengagement.

10. The preform according to claim 9, characterised in that the free ends of said first and second sub-sections (7A, 7B; 8A, 8B) take the form of end-pieces which are to be connected together by positive interengagement, said sub-sections extending parallel to one another.

11. The preform according to claim 9, characterised in that the free ends of said first and second sub-sections (9A, 9B) take the form of end-pieces which are to be connected together by positive interengagement, said sub-sections being shaped to be annular.

12. The preform according to claim 10, characterised in that said end-piece of said first sub-section (7A; 8A; 9A) and the said end-piece of the said second sub-section (7B; 8B; 9B) take the form of a snap-action or latching joint.

13. The preform according to claim 12, characterised in that said end-piece of said first sub-section (8A) having a hook-like or claw-like body (8H) and said end-piece (8B) of said second sub-section (8A) having a recess (8I) having an undercut, said hook-like or claw-like body on said first sub-section being able to be inserted in said undercut recess in said second sub-section to connect said sub-sections to form said annular hanger.

14. A method for producing a container for holding medical fluids and in particular for holding infusion solutions or solutions for enteral nutrition, having the following method steps:
provision of a preform according to claim 1,
stretching and blow-moulding of said preform into a container,
connecting of said first and second sub-sections to form an annular hanger.

15. The method according to claim 14, characterised in that said free ends of the said first and second sub-sections being welded together.

16. The method according to claim 14, characterised in that said free ends of said first and second sub-sections being connected together by positive interengagement.

17. The method according to claim 14, characterised in that said preform is produced by an injection moulding process.

18. A container for holding medical fluids and in particular for holding infusion solutions or solutions for enteral nutrition, characterised in that said container being produced by the method according to claim 14.

19. The preform according to claim 11, characterised in that said end-piece of said first sub-section (7A; 8A; 9A) and said end-piece of said second sub-section (7B; 8B; 9B) taking the form of a snap-action or latching joint.
